(19) United States
(12) Patent Application Publication
(10) Pub. No.: US 2009/0186498 A1
(43) Pub. Date: Jul. 23, 2009

(54) Connector for memory card

(75) Inventor: Kiyoshi Ooaku, Tokyo (JP)

Correspondence Address: WENDEROTH, LIND & PONACK, L.L.P., 1030 15th Street, N.W.,, Suite 400 East, Washington, DC, 20005-1503, US

(73) Assignee: Honda Tsushin Kogyo Co., Ltd.

(21) Appl. No.: 12/320,249

(22) Filed: Jan. 22, 2009

(30) Foreign Application Priority Data
Jan. 23, 2008 (JP) 2008-012505

(51) Int. Cl. H01R 12/00

(52) U.S. Cl. 439/78

(57) ABSTRACT

In order to provide a connector for a memory card that seeks the reduction of the number of parts and the reduction of the costs, there is provided a connector for a memory card including an insulating housing having plural power contacts and signal contacts lined up, and an accommodating unit for allowing installation of a memory card therein to bring an electric circuit in the memory card and an electric circuit on a printed circuit board into electrical connection through the power contacts and the signal contacts, wherein a detecting contact for detecting that the memory card has been installed to the accommodating unit is further provided in the insulating housing along the power contact and the signal contact, and a leading end of the detecting contact is placed so as to be in contact with a pad of the memory card accommodated in the accommodating unit.

### BACKGROUND OF THE INVENTION

1. Field of the Invention

The present invention relates to a connector that accommodates a memory card such as a micro SD card mainly used for data recording in a cellular phone and is to be mounted on a surface of a printed circuit board.

2. Prior Art

A conventional connector for a memory card disclosed in JP-A-2006-164604 has been known. As shown in FIG. 5, in a connector 1a for a memory card, if a memory card 2 is accommodated in an accommodating unit 3, a power supply pad 2a or signal pad 2b on one side of the memory card 2 is brought into slidable contact with a power supply contact 4a or a signal contact 4b provided in parallel at corresponding pitches thereby connecting electrically. On the other hand, on the side of the memory card 2, a part of a detecting contact 5a intruding to the accommodating space is pushed out to the outside. Thus, the part is brought into contact with a detecting contact 5b derived to a detecting circuit on a printed circuit board side thereby connecting electrically. Therefore, the fact that the memory card 2 has been installed to the accommodating unit 3 can be electrically detected.

However, in the conventional connector 1a for a memory card, the two detecting contacts 5a and 5b are provided in an insulating housing of the connector 1a as means for detecting the installation of a memory card. This increases the cost for detecting the installation of a memory card, imposes a load of parts control and increases the number of steps of assembly, which are problems.

### SUMMARY OF THE INVENTION

In view of the conventional problems, it is an object of the present invention to provide a connector for a memory card that allows the reduction of the number of detecting contacts and reduction of the costs.

According to an aspect of the invention, there is provided a connector for a memory card including an insulating housing having plural power contacts and signal contacts lined up, and an accommodating unit for allowing installation of a memory card therein to bring an electric circuit in the memory card and an electric circuit on a printed circuit board into electrical connection through the power contacts and the signal contacts, wherein a detecting contact for detecting that the memory card has been installed to the accommodating unit is further provided in the insulating housing along the power contact and the signal contact, and a leading end of the detecting contact is placed so as to be in contact with a pad of the memory card accommodated in the accommodating unit.

Preferably, a back end of the detecting contact is placed so as to connect with a detecting circuit on the printed circuit board, and the leading end of the detecting contact is placed so as to be abutted against a power supply pad of the memory card.

According to a connector for a memory card of the invention, a leading end of the detecting contact is placed so as to be in contact with a pad of the memory card accommodated in an accommodating unit, and therefore, the pad of the memory card accommodated in the accommodating unit can also be used as a detecting contact, which can reduce the number of contacts.

Furthermore, placing the back end of the detecting contact so as to connect with a detecting circuit on the printed circuit board and placing the leading end of the detecting contact so as to be abutted against a power supply pad of a memory card can reduce the costs and can reduce the mounting area more than that of a conventional connector which is provided within contacts and projects to a side of the insulating housing. Therefore, the effective mounting area can be increased on the printed circuit board.

### BRIEF DESCRIPTION OF THE DRAWINGS

FIG. 1A is a plan view showing a state removed a shell in a connector for a memory card according to an embodiment of the invention, and FIGS. 1B and 1C are a bottom view and a side elevation view, respectively, showing a state with the shell attached;

FIG. 2 is a sectional view taken on the line 2-2 in FIG. 1A;

FIGS. 3A and 3B are a plan view and a side elevation view, respectively, showing a carrier having contacts in the connector for a memory card and;

FIGS. 4A, 4B and 4C are a plan view, a front view and a side view, respectively, showing the connector for a memory card; and

FIG. 5 is a plan view showing a state removed a shell when a conventional connector for a memory card is in use.

### DETAILED DESCRIPTION OF THE PREFERRED EMBODIMENTS

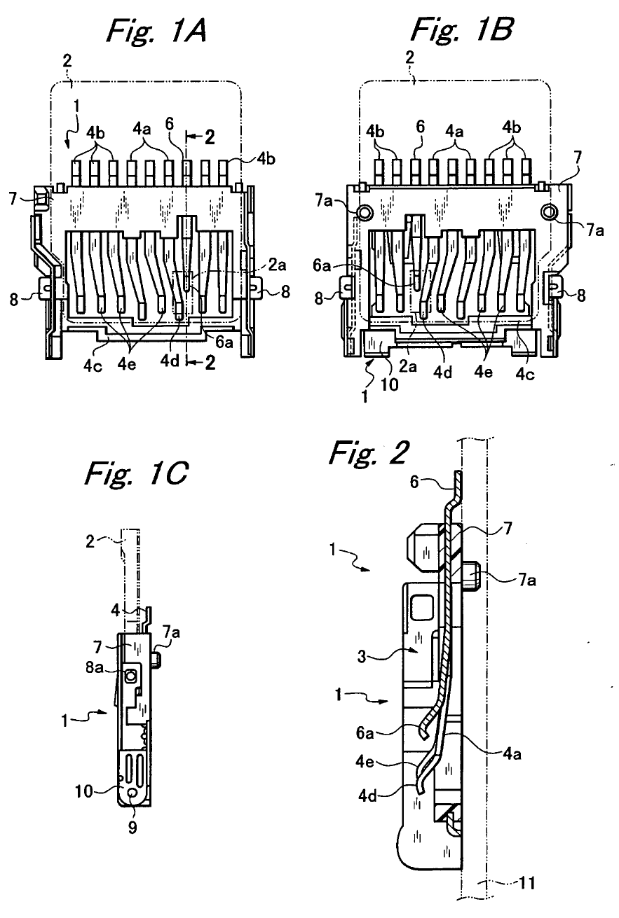

A connector 1 for a memory card according to the invention will be described by referring the parts corresponding to those of the conventional connector 1a for a memory card with identical reference numerals. The connector 1 for a memory card, as shown in FIGS. 1A and 1B, is a connector allowing the installation of a memory card 2 (refer to FIGS. 4A and 4C) into an accommodating unit 3 in an insulating housing 7 to bring an electric circuit in the memory card 2 and an electric circuit on a printed circuit board 11 shown in FIG. 2 into electrical connection through a power contact 4a and a signal contact 4b lined up in the insulating housing 7.

A detecting contact 6 for detecting that the memory card 2 has been installed to the accommodating unit 3 is additionally provided in the insulating housing 7 along the power contact 4a and the signal contact 4b, and a leading end 6a of the detecting contact 6 is placed to be in contact with a pad of the memory card 2 accommodated in the accommodating unit 3. In other words, a back end of the detecting contact 6 is placed so as to connect with a detecting circuit on the printed circuit board 11, and the leading end 6a of the detecting contact 6 is placed so as to be abutted against a power supply pad 2a (refer to FIG. 5) of the memory card 2.

The detecting contact 6 is placed closely to and by the power supply contact 4a. As shown in FIGS. 1A and 1B, the leading end 4d of the power contact 4a and the leading end 6a of detecting contact 6 are abutted against one power pad 2a, thereby allowing the power pad 2a and the power contact 4a to be shared as the detecting contact.

In another view point, the detecting contact 6 is placed among plural power contacts 4a and signal contacts 4b (contact group), and the leading ends of all the contacts (4a, 4b and 6) in the contact group are placed for the corresponding pads 2a, 2b . . . of the memory card 2. The back ends 4a, 4b and so on of the contacts on the printed circuit board 11 side is added one back end of the detecting contact 6, however, they are fit within the width of the insulating housing 7. Therefore, a narrower mounting area can be achieved for the connector 1 for a memory card than the conventional one for the connector 1a for memory card, which is wider because the detecting contact is provided on a side of the insulating housing 7. As a result, this can increase the effective mounting area on the printed circuit board 11.

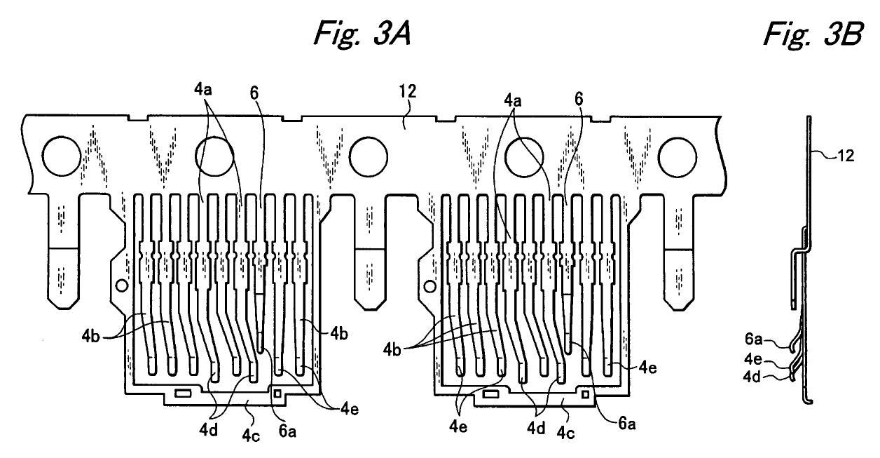

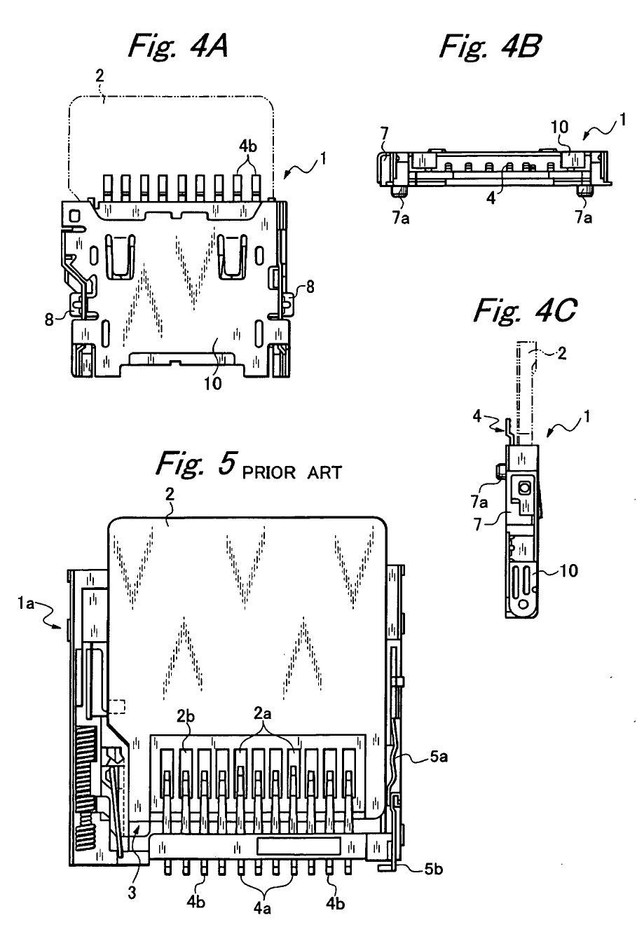

In the connector 1 for a memory card according to the invention, contacts to be integrated to the insulating housing 7 by insert molding are formed on a carrier 12 of a sheet metal, as shown in FIGS. 3A and 3B. The contacts 4a, 4b, . . . and 6 are surrounded by a reinforcing plate 4c for reinforcing the insulating housing 7.

A positioning boss 7a is used for attachment to the printed circuit board 11, and a holddown 8 is used for fixing to the printed circuit board 11. A pivot 9 supports a metallic shell 10 pivotably. As shown in FIGS. 1B and 1C and FIGS. 4A to 4C, the memory card 2 is installed into and is held within the shell 10, is pivoted about the pivot 9 with the state and is latched with a small window 8a of the holddown 8. Then, the shell 10 is closed, and the memory card 2 is accommodated in the accommodating unit 3 of the insulating housing 7.

In the connector 1 for a memory card, one detecting contact 6 is provided, and the leading end 6a is brought into slidable contact with the power pad 2a of the memory card 2. Thus, the power pad 2a and the power contact 4a can be shared as the detecting contact, which can eliminate the necessity for the contact between two independently provided detecting contacts as in conventional technologies.

What is claimed is:

1. A connector for a memory card comprising an insulating housing having plural power contacts and signal contacts lined up, and an accommodating unit for allowing installation of a memory card therein to bring an electric circuit in the memory card and an electric circuit on a printed circuit board into electrical connection through the power contacts and the signal contacts, wherein:
a detecting contact for detecting that the memory card has been installed to the accommodating unit is further provided in the insulating housing along the power contact and the signal contact, and a leading end of the detecting contact is placed so as to be in contact with a pad of the memory card accommodated in the accommodating unit.

2. The memory card connector according to claim 1, wherein a back end of the detecting contact is placed so as to connect with a detecting circuit on the printed circuit board, and the leading end of the detecting contact is placed so as to be abutted against a power supply pad of the memory card.
